(19) United States
(12) Patent Application Publication
(10) Pub. No.: US 2006/0086690 A1
(43) Pub. Date: Apr. 27, 2006

(54) Dielectric etching method to prevent photoresist damage and bird's beak

(76) Inventors: Ming-Huan Tsai, Hsinchu (TW); Fong-Yuh Yen, Taoyuan County (TW); Hun-Jan Tao, HsinChu (TW)

Correspondence Address: DUANE MORRIS LLP;IP DEPARTMENT (TSMC), 30 SOUTH 17TH STREET, PHILADELPHIA, PA, 19103-4196, US

(21) Appl. No.: 10/971,265

(22) Filed: Oct. 21, 2004

(51) Int. Cl. C23F 1/00; C03C 25/68; B44C 1/22

(52) U.S. Cl. 216/41; 216/58; 216/74

(57) ABSTRACT

A method of dry etching a dielectric layer is provided that prevents or significantly reduces deep ultraviolet photoresist damage and bird's beak problems. The dry etch method provided comprises the steps of providing a substrate having a dielectric layer overlying at least a portion of the substrate's surface; applying a deep ultraviolet (DUV) photoresist mask having a pattern of exposed area on at least a portion of the dielectric layer; and etching the masked dielectric layer with a plasma formed from a mixture of gases comprising a gaseous fluorine species, hydrogen, and helium.

### FIELD OF THE INVENTION

The present invention relates to the field of fabricating semiconductor devices, and particularly to a dry etching method that prevents or significantly reduces deep ultraviolet (DUV) photoresist damage and bird's beak problems.

### BACKGROUND

In the fabrication of semiconductor devices, it is often desired to etch certain areas of a dielectric layer formed on a semiconductor substrate. Via or contact etching is performed to create contact openings in the dielectric layer. In lithographic processing of semiconductor substrates, a photoresist layer is deposited and patterned by selective exposure to an energy beam, and developed to form patterned exposed areas. One or more of the underlying layers of the patterned exposed areas are then selectively etched. In the prior art, for example, in a damascene process, this has been most readily accomplished by plasma or reactive ion etching of a dielectric layer (e.g., silicon oxide).

U.S. Pat. No. 6,686,296 discloses that the extension of 248 nm lithography has in many cases led to the introduction of more sensitive photoresists. Many of these photoresists have demonstrated poor performance with traditional dry etch processes. Deep ultraviolet (DUV) photoresists have demonstrated increased sensitivity to etch processes for the underlying layers. This has been an important issue with regard to etching of underlying organic coatings, particularly organic anti-reflective coatings (ARC), which are in turn applied over dielectric layers. Forming an opening that reaches to an organic ARC (anti-reflective coating) layer is often one of the most challenging steps in which to maintain photoresist integrity.

High density plasma (HDP) etching tools, when applied to organic ARC etching, have suffered from poor DUV photoresist protection due to their aggressiveness, e.g., high ion flux and high dissociation fraction. This has made implementation of the HDP sources for dielectric etching difficult using DUV photoresists. For this reason, ARC etching using sensitive photoresists has been performed in a traditional low power plasma etch tool to minimize damage. However, much of the throughput advantage of a high density plasma tool is lost when a conventional tool must be used to open the ARC layer, as it in turn leads to a loss of etch rate and possibly a reduction of anisotropy.

Furthermore, U.S. Pat. No. 6,686,296 discloses a method for etching ARC layers utilizing a high density plasma etchant containing argon, fluorine, and nitrogen. The method is particularly useful where the organic film is an organic antireflective coating, and the photoresist layer comprises a deep ultraviolet photoresist material. The patterned photoresist layer is consumed more slowly than the organic film layer, and the etchant removes substantially all of the organic film in the area contacted by the etchant. The substrate may include an oxide layer underlying the organic film layer, such that the etchant removes substantially all of the organic film in the area contacted by the etchant and exposes an area of the oxide layer, and the oxide layer is substantially undamaged after contact with the etchant.

U.S. Pat. No. 5,549,784 discloses a method of reactive-ion etching a silicon oxide dielectric layer which is used as an insulating layer between the gate regions and the interconnects in a semiconductor device. Typically, a fluorine-oxygen gas mixture or chemistry is used for the etching of silicon oxide films. The gas is introduced to the chamber and RF energy is applied to produce the plasma. Etching takes place until the RF energy is removed, with the timing of the process, pressure, RF energy and flow rate controlling the depth of etching. The preferred method utilizes a plasma including fluorine, oxygen, and helium.

The need for higher density semiconductor devices continues to force smaller feature sizes and closer packing of etched areas. Extensions of lithographic methods using DUV photoresists to achieve closer packing results in etch damage under the DUV photoresist, such as striation or contact/via bird's beak between two individual patterns. This damage can produce a short between two pattern areas and result in serious yield loss.

Therefore, there is a need for a contact and via dry etch process that can be used on a variety of dielectric layers to provide minimal DUV photoresist damage and finer detail at high yield.

### SUMMARY OF THE INVENTION

In some embodiments, a method of dry etching a dielectric layer comprises the steps of providing a substrate having a dielectric layer overlying at least a portion of the substrate's surface; applying a deep ultraviolet (DUV) photoresist mask having a pattern of exposed area on at least a portion of the dielectric layer; and etching the masked dielectric layer with a plasma formed from a mixture of gases comprising a gaseous fluorine species, hydrogen, and helium.

### BRIEF DESCRIPTION OF THE DRAWINGS

FIG. 1 is a process flow diagram of one embodiment of the present invention.

FIG. 2 is an electron beam photomicrograph of a prior art argon etched product employing a patterned DUV photoresist in a 65 nm generation contact etch process on a silicon substrate having an overlying silicon oxide layer. The photomicrograph shows significant bird's beak and striation defects.

FIG. 3 is an electron beam photomicrograph of a second sample of the same patterned substrate of FIG. 2, etched by a method according to one embodiment of the present invention. The photomicrograph shows no bird's beak and minimum striation defects.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

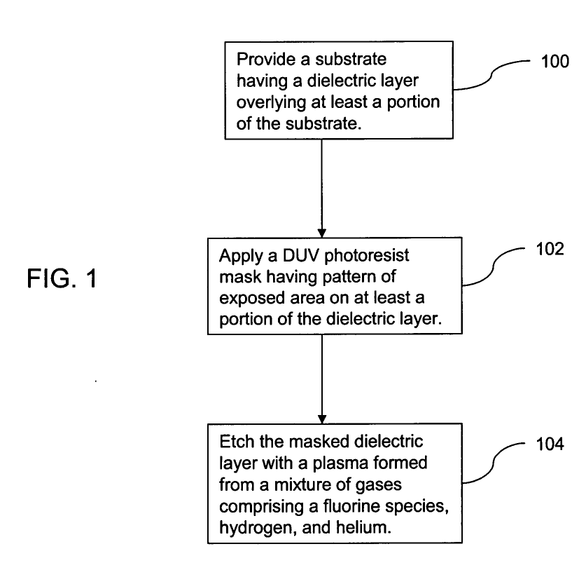

Referring to FIG. 1, in some embodiments, a method of dry etching a dielectric layer comprises the steps of: at step 100 providing a substrate having a dielectric layer overlying at least a portion of the substrate's surface; at step 102 applying a deep ultraviolet (DUV) photoresist mask having a pattern of exposed area on at least a portion of the dielectric layer; and at step 104 etching the masked dielectric layer with a plasma formed from a mixture of gases comprising a gaseous fluorine species, hydrogen, and helium.

The substrate having an overlying dielectric layer can comprise any substrate. Preferably the substrate is a semiconductor substrate, which may be the surface of a wafer, or a wafer having one or more layers of material formed thereon. The substrate may comprise any semiconductor device or devices, including integrated circuits.

In some embodiments, the dielectric layer overlying the substrate may comprise silicon oxide, phospho silicate glass (PSG), borophospho silicate glass (BPSG), fluorinated silica glass (FSG), plasma tetra ethyl oxysilane (PTEOS), TTEOS, carbon-doped oxide, organic spin-on material, or a mixture thereof. In some embodiments, the dielectric layer is a single layer, but multiple dielectric layers can also be employed.

The DUV photoresist overlying at least a portion of the dielectric layer can comprise any well known deep ultraviolet (DUV) photoresist composition. The DUV photoresist may comprise either a positive or negative photoresist composition, and may be employed in a 248 nm, 193 nm, or 157 nm process.

In some embodiments, the plasma composition is formed from a mixture of gases comprising a gaseous fluorine species, hydrogen, and helium. The gaseous fluorine species may comprise CH₂F₂, CHF₃, C₂F₆, C₄F₈, C₅F₈, C₄F₆, CF₄, or a mixture thereof. Hydrogen within the gas mixture reduces the reactivity of the DUV photoresist with the plasma, and protects the photoresist from plasma damage. In some embodiments, the ratio of hydrogen to gaseous fluorine species is at least 0.01. In some embodiments, the gaseous composition may further comprise a gaseous additive to help hydrogen ionization and generate more hydrogen species within the plasma thereby enhancing protection. In some embodiments, the additive may include neon, argon, krypton, xenon, or a mixture thereof.

In some embodiments, the mixture of gases should comprise helium at a level greater than about 50%. Helium has a high ionization energy when compared to traditional etch gases such as Argon. Therefore, fewer helium ions are generated in the plasma. Additionally, the low ion mass of ionized helium (mass=4 atomic mass units, or AMU) is significantly less than that of Argon (mass=40 AMU). Therefore, the momentum of a helium ion impacting the photoresist is much less than that of an impacting Argon ion. This in itself reduces damage to the photoresist. Although heavier gases such as Argon may be used as additives to assist hydrogen ionization as described above, care should be taken to control the amount of the additive in the gas mixture.

In some embodiments, the mixture of gases may further comprise a gaseous oxygen component. Examples of such gaseous mixtures may include CHxFy/O₂/He; CxFy/O₂/He; and CxFy/CHxFy/O₂/He. Optionally, some CO may be included in the gas mixture, or some CO may replace part of the O₂. Optionally, Ar may be added to the mixture. The gaseous oxygen containing component may be oxygen, carbon monoxide, carbon dioxide, or a mixture thereof. When an oxygen containing component is used, the amount should be controlled to ensure that damage does not occur to the DUV photoresist.

The high density plasma may be generated within a wide variety of dry etching equipment. In some embodiments, a 248 nm process may be used (e.g., a device with a pitch of at least 0.3 micrometers). A plasma may be formed within a single frequency etching apparatus at a power between about 500 watts to about 5000 watts. In other examples, the plasma may be formed within a dual frequency etching apparatus at a first frequency with a power between about 500 watts to about 4000 watts, and at a second frequency with a power between about 500 watts to about 4000 watts. The pressure within the etching apparatus may be between about 10 milliTorr to about 250 milliTorr.

In other embodiments, the plasma may be formed within a single power or multi-power, inductive or conductive etching apparatus at a power of between about 1000 watts to about 3000 watts, and at a pressure greater than about 30 milliTorr. Depending upon the dielectric layer, the composition of the gas mixture, and the amount of etch required, these conditions can be varied outside these ranges.

The dielectric layer and DUV photoresist may be exposed to the plasma generated within the dry etch apparatus, and exposure maintained until the desired level of etching is achieved. Various methods of determining the level of etch are well known in the art.

In some embodiments, the exemplary method has been shown to prevent DUV photoresist damage and eliminate striation and bird's beak defects. In some embodiments, the exemplary method is of value in contact etch, via etch and damascene trench etch processes. Particularly, the exemplary method extends the use of DUV photoresists.

### EXAMPLES

An example is provided for the purpose of illustration only, and the invention is not limited to the example, but rather encompasses all variations which are relevant as a result of the teachings provided herein.

### Example 1

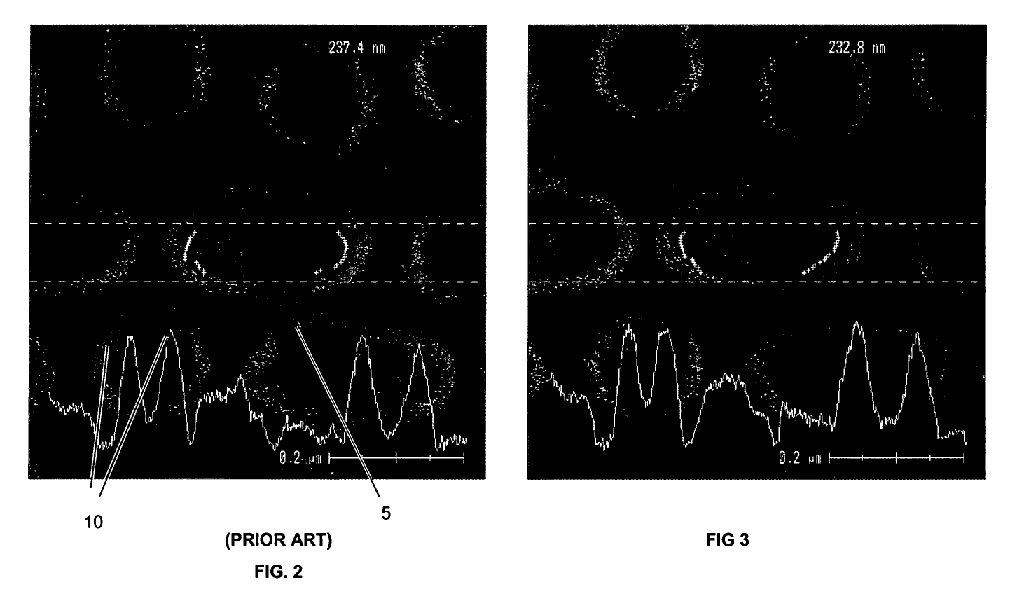

In one comparative example, a patterned DUV photoresist was used in a 65 nm generation contact etch process on a silicon substrate having an overlying layer of silicon oxide. The dry etch method described above with reference to FIG. 1 was compared to a standard Argon dry etch method. Referring to FIG. 2, the standard Argon etched substrate showed significant bird's beak 5 and striation 10 defects. Referring to FIG. 3, the dry etch method of the exemplary method provided an etched substrate with no significant bird's beak between individual patterns, and significantly reduced striation.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of dry etching a dielectric layer comprising the steps of:
providing a substrate having at least a dielectric layer overlying at least a portion of the substrate;
applying a deep ultraviolet photoresist mask having a pattern of exposed area on at least a portion of said dielectric layer to provide a masked dielectric layer;
etching the masked dielectric layer with a plasma formed from a mixture of gases comprising a fluorine species, hydrogen, and helium.

2. The method of claim 1, wherein the mixture of gases includes at least 50% helium.

3. The method of claim 1, wherein said mixture of gases further comprises a gaseous oxygen component.

4. The method of claim 3, wherein said gaseous oxygen component is selected from the group consisting of oxygen, carbon monoxide, carbon dioxide, and a mixture thereof.

5. The method of claim 1, wherein said mixture of gases further comprises a gaseous additive to increase hydrogen ionization.

6. The method of claim 5, wherein said gaseous additive is selected from the group consisting of neon, argon, krypton, xenon, and a mixture thereof.

7. The method of claim 1, wherein said dielectric layer is one of the group consisting of silicon oxide, PSG, BPSG, FSG, PTEOS, TTEOS, carbon-doped oxide, organic spin-on material, and a mixture thereof.

8. The method of claim 1, wherein said fluorine species is one of the group consisting of CH₂F₂, CHF₃, C₂F₆, C₄F₈, C₅F₈, C₄F₆, CF₄, and a mixture thereof.

9. The method of claim 8, wherein the ratio of said hydrogen to said fluorine species is at least 0.01.

10. The method of claim 1, wherein the etching step includes etching a contact, a via, or a damascene trench.

11. The method of claim 1, wherein said plasma is formed within a single power or multi-power, inductive or conductive etching apparatus at a power of between about 1000 watts to about 3000 watts, and at a pressure greater than about 30 milliTorr.

12. The method of claim 1, wherein said photoresist mask comprises multiple layers.

13. The method of claim 1, wherein said photoresist is applied using a 248 nanometer, 193 nanometer, or 157 nanometer lithographic process.

14. A semiconductor substrate comprising at least a dielectric layer overlying at least a portion of said semiconductor substrate, wherein said dielectric layer comprises at least one etched area formed by the dry etching method of claim 1.

15. The semiconductor substrate of claim 14, wherein said overlying dielectric layer is at least one of the group consisting of silicon oxide, PSG, BPSG, FSG, PTEOS, TTEOS, carbon-doped oxide, organic spin-on material, and a mixture thereof.

16. A semiconductor device comprising at least one region formed by a process including the dry etching method of claim 1.
